(19) United States
(12) Patent Application Publication
(10) Pub. No.: US 2005/0042584 A1
(43) Pub. Date: Feb. 24, 2005

(54) Interactive magnetic book and display system and method

(76) Inventor: Roy V. Ekberg, Ottawa, KS (US)

Correspondence Address: HARSHAW RESEARCH INCORPORATED, P O BOX 418, OTTAWA, KS, 66067, US

(21) Appl. No.: 10/643,399

(22) Filed: Aug. 19, 2003

(51) Int. Cl. G09B 5/00

(52) U.S. Cl. 434/169

(57) ABSTRACT

An interactive magnetic book and display system includes a display board having a plurality of magnets spaced apart beneath its surface. A book having covers with metallic elements imbedded therein may be placed on a book receiving section of the display board and be magnetically held thereon by the magnets. A story text is imprinted on the book's pages with a first set of distinctive markings being imprinted within the story text. The system includes a set of cards with each card having an imbedded metallic element and being individually imprinted with a second set of distinctive markings corresponding to the first set. As a user reads the story text and encounters one of the first set of markings, a card from the card set having a corresponding marking may be positioned on the display board and magnetically held thereon.

### BACKGROUND OF THE INVENTION

This invention relates to books and games and, more particularly, to an interactive magnetic book and display system and a method for using the invention.

Most parents desire that their children read books and develop an overall interest in educational pursuits. Educational games and books are more likely to be used repeatedly if they include an entertainment or interactive aspect. Interactive books that include an audio or visual component have become popular since they hold the interest of a child better than a conventional book.

Although interactive books and games have been proposed in the art, the existing devices do not provide a stable and entertaining structure or method for displaying a book and related cards.

Therefore, it is desirable to have a system for magnetically holding a book and associated cards for use in an interactive manner. Further, it is desirable to have a system having embedded magnets and metallic elements to facilitate holding the book and cards but without being visible. In addition, it is desirable to have a system in which a set of cards includes distinctive markings that correspond to distinctive markings imprinted within a story text and which provide an interactive aspect to viewing a book.

### SUMMARY OF THE INVENTION

An interactive magnetic book and display system includes a display board having a plurality of magnets spaced apart beneath a top surface thereof. The system includes a book having front and back covers with multiple pages therebetween. Metallic elements are embedded in the front and back covers such that the covers are magnetically drawn to corresponding magnets within the display board when the book is placed thereon. This is an advantage in that the book remains in a stable configuration when the system is used while traveling in a vehicle or when otherwise subjected to movement. No special clips or inconvenient fasteners are needed. A story text is imprinted on the book's pages with a first set of distinctive markings, like graphical icons, imprinted at appropriate locations throughout the story text. The system includes a set of cards having a second set of distinctive markings imprinted upon individual cards. The second set of markings includes illustrations corresponding to the first set of markings. Each card also includes a metallic element embedded beneath its outer surface such that the card may be positioned on the display board and held magnetically thereto when the card's corresponding icon is encountered by a user reading the story text.

Therefore, a general object of this invention is to provide an interactive book and display system which includes a display board having a plurality of magnets beneath its surface.

Another object of this invention is to provide a system, as aforesaid, having a book with metallic elements embedded in its covers for being placed and held on the display board.

Still another object of this invention is to provide a system, as aforesaid, which includes a set of cards having metallic elements such that the cards may be placed and held on the display board adjacent the book.

Yet another object of this invention is to provide a system, as aforesaid, in which a story text is imprinted on the pages of the book with a first set of distinctive markings being imprinted at predetermined locations throughout the story text.

A further object of this invention is to provide a system, as aforesaid, which includes a second set of distinctive markings imprinted individually on the set of cards and which correspond to the first set of distinctive markings.

A still further object of this invention is to provide a system, as aforesaid, which enables a user to place a card on the display board having a marking that corresponds to a particular one of the first set of distinctive markings encountered while reading the story text.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an interactive magnetic book and display system according to a preferred embodiment of the present invention with a book and card elements in one configuration;

FIG. 2 is another perspective view of the system as in FIG. 1 with the book and card elements in another configuration;

FIG. 3 is an exploded view of a card according to the system as in FIG. 1;

FIG. 4 is a diagrammatic top view of the display board as in FIG. 1 with internal magnets being shown with phantom lines; and

FIG. 5 is a block diagram of an interactive magnetic book and display system according to another embodiment of the present invention.

### DESCRIPTION OF THE PREFERRED EMBODIMENT

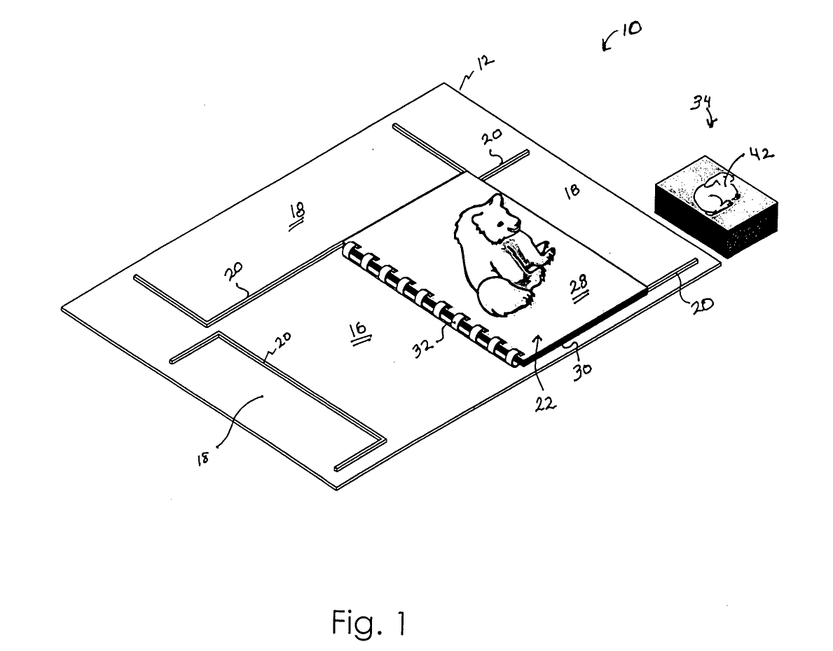

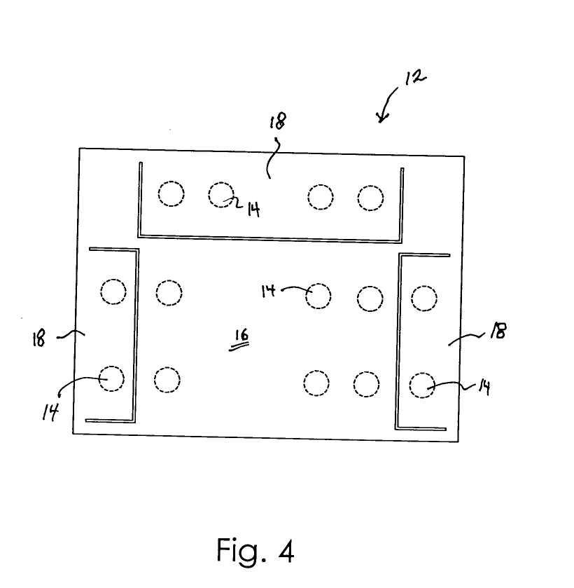

An interactive magnetic book and display system according to the present invention will now be described in detail with reference to FIGS. 1 through 5 of the accompanying drawings. As shown in FIG. 1, a system 10 according to one embodiment includes a display board 12 having a generally flat rectangular configuration although other configurations would also be suitable. The display board 12 includes a top and bottom surface and includes a plurality of magnets 14 embedded in spaced apart relation beneath the top surface (FIG. 4). Preferably, each magnet 14 includes a disk-shaped configuration although magnets having other configurations would also work. The display board 12 is segmented into a book receiving section 16 with card receiving sections 18 spaced apart adjacent to the book receiving section 16. The purpose of these sections will be described in further detail below. Divider partitions 20 in the form of slightly raised walls or ledges separate the sections. It is understood that the magnets 14 are positioned beneath each section as shown in FIG. 4.

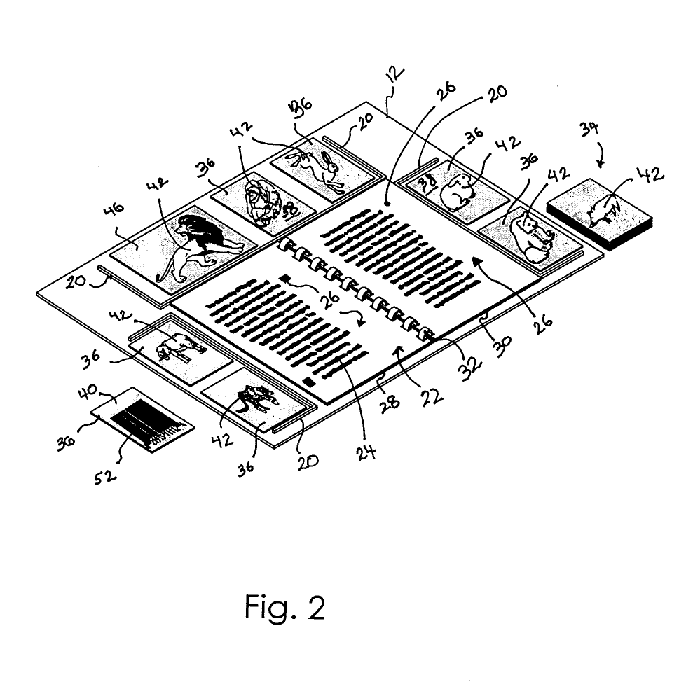

The system 10 includes a book 22 having multiple pages with a story text 24 being imprinted on those pages (FIG. 2). Further, a first set of distinctive markings 26 are positioned at predetermined locations throughout the story text 24. Preferably, the first set of markings includes small illustrations or icons that correspond to very similar larger illustrations on a set of cards, as to be described later.

The pages are contained between front 28 and back 30 covers connected along a spine 32 or binder such that the book 22 may be opened and closed in a conventional manner. Each of the covers includes metallic elements embedded beneath outer surfaces thereof. Therefore, the metallic elements within the covers are magnetically drawn to corresponding magnets 14 in the display board 12 when the book 22 is positioned on the book receiving section 16 thereof (FIGS. 1 and 2). Thus, the book 22 is held in a stable position while other components of the system 10 are manipulated, as to be further described below. It is understood that books having different story texts may be utilized with the display board 12.

The system 10 further includes a set of cards 34 having a second set of distinctive markings 42 imprinted individually upon one side of respective cards. The second set of markings 42 correspond to the first set of markings 26 that are dispersed throughout the story text 24 and, as such, are preferably ordered according to the order in which the first set of markings 26 are encountered when reading the story text 24. The second set of markings 42 may include a plurality of separate and distinct illustrations although some may be repeated depending on the particular story text 24 that the cards are associated with.

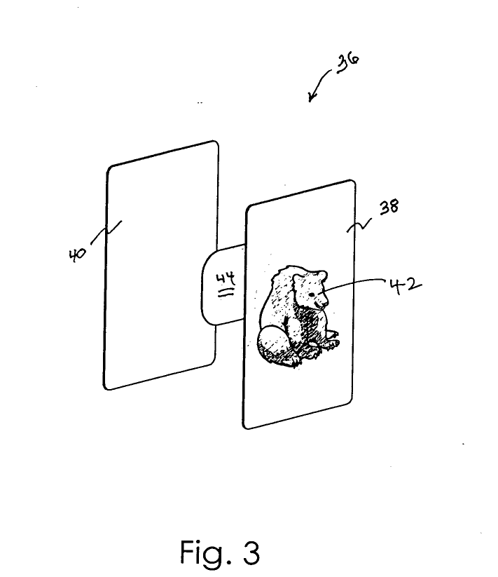

At least one metallic element 44 is sandwiched between front 38 and back 40 surfaces of the card 36 (FIG. 3) such that each card 36 is magnetically drawn to a corresponding magnet 14 in the display board 12 when the card is positioned in a card receiving section 18 thereof (FIG. 2). Thus, each card 36 is removably held to the display board 12 during use and will not inadvertently fall therefrom if the board is tilted, bumped, etc. Preferably, each card 36 includes a uniform size and configuration similar to that of conventional playing cards. However, the set of cards 34 may include one or more double-sized cards 46 as shown in FIG. 2. It should be appreciated that a double-sized card 46 may include more than one metallic element embedded therein and is capable of being magnetically held to a corresponding number of display board magnets 14 when positioned on the display board 12. This relationship is apparent in viewing the placement of display board magnets 14 as shown in FIG. 4.

It is understood that thin, disk-shaped magnets and metallic elements are preferred in that they provide manufacturing, assembly, and economic advantages although other configurations would also be suitable. Further, it should be appreciated that magnets may be positioned within the cards and book covers with metallic elements positioned in the display board 12, or that magnets with appropriate polarity may be used in both locations.

In use, the display board 12 may be positioned by a user, such as a child, on a table, on a car seat, or on a user's lap. A book 22 may be selected and positioned on the book receiving section 16 of the display board 12 and opened to a first page. A corresponding set of cards 34 may be selected and positioned adjacent the display board 12 or otherwise in close proximity. As the user visually scans the story text 24 so as to read the story, particular ones of the first set of distinctive markings 26 will be encountered. These markings correspond to the markings on individual cards of the set of cards 34 and prompt the user to place the appropriate card upon one of the card receiving sections 18 of the display board 12. This action makes the book and display system 10 interactive. Essentially, the user is supplying the illustrations to the story at the appropriate time. This process may be repeated each time an icon from the first set of markings 26 is encountered in the story text 24. Of course, cards placed upon the display board 12 may from time to time need to be removed to make room for more cards. The book 22 and set of cards 34 are magnetically held to the display board 12 until specifically removed by the user.

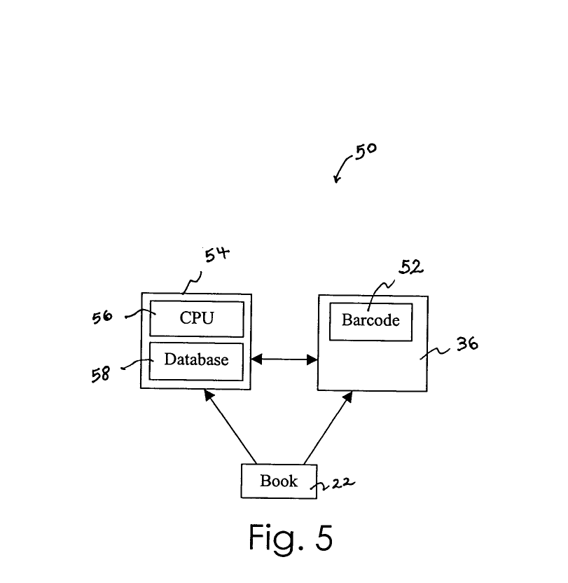

A system 50 according to another embodiment of this invention is shown in FIGS. 2 and 5 and includes a construction substantially similar to the construction described above except as specifically noted below. In this embodiment, each card in the set of cards 34 includes a unique barcode 52 imprinted on the back of the card (FIG. 2). This embodiment assumes usage of a barcode reader (not shown) such as is known in the art. Further, this system 50 includes a computer 54 or similar electronic device or component having a database 58, the database including a table of barcodes and corresponding output signals. The computer 50 also includes a central processing unit (CPU) 56 electrically connected to the database 58. The barcode reader may be connected to the computer 54 using a conventional interface. Therefore, when a user encounters a particular one of the first set of markings, e.g. an icon, in the story text 24 and selects a card having a corresponding one of the second set of markings, the user may scan that card's barcode 52. When this barcode 52 is communicated to the computer 54, the CPU 56 is capable of processing this code and generating appropriate output signals referenced in the database 58. These output signals may be directed to various output peripheral devices (not shown) such as a speech synthesizer, audio playback device, video monitor, or the like.

Therefore, the interactivity provided by this system 50 may involve considerable high technology for the amusement, entertainment, and education of the user. It should be appreciated that this advanced system 50 has many applications and may be utilized to enhance educational presentations from the elementary school to university level and even corporate seminars. For example, accessing a barcode imprinted in a textbook or seminar handout, a user may be able to view a more detailed discussion of a particular point. This is advantageous in that the detail need not be presented unless desired by a user.

It is understood that while certain forms of this invention have been illustrated and described, it is not limited thereto except insofar as such limitations are included in the following claims and allowable functional equivalents thereof.

1-7. (Canceled)

8. An interactive magnetic book and display system, comprising:
a display board having a book receiving section and at least one card receiving section, said book and card receiving sections being separated from one another;
a plurality of magnets positioned beneath a top surface of said display board only in said book receiving section and said at least one card receiving section;
a book having a story text imprinted therein and a first set of distinctive markings imprinted therein at predetermined locations in said story text;
wherein said book includes front and back covers having metallic elements positioned beneath respective first surfaces thereof, said metallic elements being configured to be magnetically drawn to corresponding magnets of said plurality of magnets of said display board when said front and back covers are positioned on said book receiving section; and
a set of cards having a second set of distinctive markings imprinted on respective cards, said second set of distinctive markings corresponding to said first set of distinctive markings, said set of cards being ordered such that said second set of distinctive markings are encountered in the same order as said first set of distinctive markings are encountered in said story text.

9. The system as in claim 8 wherein each of said set of cards includes:
a card first surface; and
a card metallic element positioned beneath said card first surface such that said card metallic element is magnetically drawn to a corresponding magnet of said plurality of magnets when said card metallic element is positioned within said card receiving section of said display board.

10. The system as in claim 8 wherein each of said plurality of cards includes a barcode imprinted thereon; said system further comprising:
a central processing unit (“CPU”);
means coupled to said CPU for communicating a selected barcode from a respective card to said CPU; and
means in said CPU for processing said selected barcode and generating an output signal corresponding to said selected barcode.

11. The system as in claim 8 wherein each of said plurality of magnets includes a disk-shaped configuration.

12-14. (canceled)

15. An interactive magnetic book and display system, comprising:
a display board having a book receiving section and at least one card receiving section, said book and card receiving sections being separated from one another;
at least one divider partition for separating said book and card receiving sections;
a plurality of magnets positioned beneath a top surface of said display board only in said book receiving section and said at least one card receiving section;
a book having a story text imprinted therein and a first set of distinctive markings imprinted therein at predetermined locations in said story text;
wherein said book includes front and back covers having metallic elements positioned beneath respective first surfaces thereof, said metallic elements being configured to be magnetically drawn to corresponding magnets of said plurality of magnets of said display board when said front and back covers are positioned on said book receiving section; and
a set of cards having a second set of distinctive markings imprinted on respective cards, said second set of distinctive markings corresponding to said first set of distinctive markings, said set of cards being ordered such that said second set of distinctive markings are encountered in the same order as said first set of distinctive markings are encountered in said story text.

16. The system as in claim 15 wherein each of said set of cards includes a barcode imprinted thereon; said system further comprising:
a central processing unit (“CPU”);
means coupled to said CPU for communicating a selected barcode from a respective card to said CPU; and
means in said CPU for processing said selected barcode and generating an output signal corresponding to said selected barcode.
